(19) United States
(12) Patent Application Publication
(10) Pub. No.: US 2023/0065043 A1
(43) Pub. Date: Mar. 2, 2023

(54) METHOD OF APPLYING A WEAR-RESISTANT COATING ON A YANKEE DRYING CYLINDER

(71) Applicant: VALMET AKTIEBOLAG, Sundsvall (SE)

(72) Inventors: Daren J. GANSERT, Placentia, CA (US); Andrew CROSS, Jakarta Selatan (ID)

(21) Appl. No.: 17/446,048

(22) Filed: Aug. 26, 2021

(51) Int. Cl. C23C 4/08; C23C 4/18; C23C 4/02; C22C 38/58; C22C 38/54; C22C 38/50; C22C 38/46; C22C 38/48; C22C 38/44; C22C 38/06; C22C 38/02

(52) U.S. Cl. CPC C23C 4/08; C23C 4/18; C23C 4/02; C22C 38/58; C22C 38/54; C22C 38/50; C22C 38/46; C22C 38/48; C22C 38/44; C22C 38/06; C22C 38/02

(57) ABSTRACT

A method of applying a long lasting wear-resistant coating on a Yankee drying cylinder (1), the method comprises:
the step of providing a Yankee drying cylinder (1) having a cylindrical shell (2) with a circular cross-section and an outer surface (3);
the step of performing a thermal spray operation to form a wear-resistant coating layer (4) on the outer surface of the Yankee drying cylinder (1) during which thermal spray operation coating feedstock (6) is fed to at least one spray device (5), heated to become plastic and/or semi-molten and/or molten and sprayed onto the outer surface (3) of the Yankee drying cylinder (1) to form the wear-resistant coating layer (4), the coating feedstock (6) for the thermal spray operation consisting of:
1.5 to 2.5 weight percent Al
0.0 to 0.2 weight percent Ti,
9.5 to 10.5 weight percent Si,
0.0 to 0.2 weight percent B,
12.5 to 14.2 weight percent Mo,
0.0 to 0.2 weight percent V,
0.0 to 0.2 weight percent C,
0.000 to 0.020 weight percent Cr,
4.5 to 6.0 weight percent Mn,
0.0 to 0.2 weight percent Mg,
0.0 to 0.2 weight percent Ni,
0.0 to 0.2 weight percent Nb,
the remainder being iron and impurities.

Coatings and Yankee cylinders with such coatings are also disclosed.

### FIELD OF THE INVENTION

The present disclosure relates in general to a method of applying a wear-resistant coating on a Yankee drying cylinder.

### BACKGROUND OF THE INVENTION

In the process of making paper, particularly in the process of making tissue paper such as kitchen, towel, facial or bathroom grades, a fibrous web that has been formed in a forming section is typically dried on a Yankee drying cylinder typically constructed of cast iron or steel or a combination of both, which is normally heated from within by hot steam. These drums which expand and contract with the internal steam heat and pressure carry the moisture containing paper web partway around their circumference to a take-off point marked by a separation or creping doctor blade which acts to separate the fibrous tissue or paper web from the drum for collection on a take-up roll. Yankee dryer drums are subject to wear from friction, i.e. tribological wear, as well as from chemical wear or erosion caused by chemical action, e.g. by chloride, fluoride and sulfite ion interactions during papermaking operations. Surface imperfections, such as surface roughness may develop, and this may cause the doctor blade, and possibly also the Yankee, to wear prematurely and irregularly whereby the tissue or paper quality is adversely affected. To avoid this, the Yankee dryer drum may be periodically reground, repolished, or thermal arc sprayed when surface imperfections become too significant to allow for tissue or papermaking operations. Resurfacing of the dryer by the above processes is costly in downtime, lost tissue or paper production, and the cost for overhaul of the Yankee dryer drum surface.

The methods of improving the tribological and erosive wear resistance of Yankee dryer drums including thermal arc spraying the drum have been a long standing proven Valmet process technology for over 3.5 decades, mostly using iron based raw materials and certain thermal arc processes that use a wire comprised of an iron based superalloy (a super alloy is an alloy with the ability to operate at a high fraction of its melting point) to form an amorphous and/or microcrystalline coating which can be subsequently ground to shape. The coated Yankee dryer drum has a hard, wear resistant coating that wears at a lower rate than the original surface. The coating is homogenous and wears slowly—it has a consistent composition throughout its thickness. An example of such a coating is known from U.S. Pat. No. 6,171,657 where the alloy is thermally sprayed onto the surface of the Yankee dryer drum. This coating contains from around 20% to 47% by weight Chromium metal and toxic Hexavalent Chromium (Cr⁺⁶) fumes are generated during the coating process. The present new invention is concerned with materials and methods for providing Yankee dryer drums with a coating with the desired mechanical and physical properties as well as creating a coating process that reduces toxic fumes related to the generation of Hexavalent Chromium (Cr⁺⁶) that is produced using high Chrome containing raw materials.

The reduction of hexavalent chromium fumes has been a focus of worldwide industry for many years and the use of processes which produce such fumes is becoming restricted, is restricted and, in some regions, banned. Under executive order (EO) 13423 Hard Chrome Alternative Technologies (HCAT) was developed to reduce the amount of Hexavalent Chrome in these chrome containing systems produced in the US. A number of attempts have been made to introduce Cr⁶⁺ free materials and processes for coating Yankee cylinders. These previous solutions have been found to be less robust than expected, due in part, to the lack of validated, accelerated testing methods, resulting in unexpected failures.

It is an object of the present invention to provide an improved, substantially chromium-free coating and method of forming a wear-resistant coating on a Yankee drying cylinder.

### DISCLOSURE OF THE INVENTION

The present disclosure relates to a method of applying a wear-resistant coating on the outer surface of a Yankee drying cylinder shell (also known as a drum). The present method is applicable to either new or refurbished Yankee dryers, such as Yankee dryers comprising a cylindrical shell made of cast iron and/or steel materials. The Yankee dryer drum is trued and either set in a jig or the existing machine frame is used for application of the coating onto the typical drum body. The drum body may be rotated in front of a thermal spray apparatus and the material for the coating, supplied in wire or powder form, is heated to become plastic and/or semi-molten and/or molten and sprayed onto the drum surface. There are various thermal spray coating processes that may be used in the application method. In an arc spray device, for example a twin wire arc spray, a wire is melted in an electric arc forming microdroplets which are blown at high velocity onto the drum surface.

In a hypervelocity thermal spray device such as a high velocity oxygen fuel (HVOF), high velocity air fuel (HVAF) spray device, a powder of the desired coating material is introduced into an oxygen and fuel mix. The oxygen and fuel mix is combusted. The powder is heated by the combustion process and the expansion of the exhaust gas accelerates the powder to very high speeds. The heated powder particles are in a plastic and/or semi-molten and/or molten state and are directed towards the Yankee drum surface. Upon impact with the drum surface the energy of the impact causes the powder particles to deform and form a dense coating. Preferably the thermal spraying conditions are adapted to each different composition and size of powder or wire so that the dense coating is non-homogeneous in structure and is a porous coating with microcracks and particle boundary layers between the re-solidified particles which act as stress relievers, thereby increasing the durability and reducing the brittleness of the coating. It is believed that such a porous coating comprises un-melted particles, lamella of re-solidified particles, voids, and oxide inclusions.

Other thermal spray coating processes may be used such as plasma spraying, water stabilized plasma spraying and combustion powder or wire spraying. The powder or wire feedstock can be heated by combustion e.g. in the exhaust gas stream of a fuel (e.g. hydrogen, propane, propylene, kerosene) mixed with air or oxygen or by electricity. The feedstock enters the heated gas and is heated to become plastic and/or semi-molten and/or molten to form droplets which are transported at high velocity onto the surface to be coated.

Wear-resistant coating layers of 100-1990 μm are usefully employed. Porosity in the coating should preferably be limited to being equal to or less than 5% and preferably is greater than or equal to 1% as determined by inspection using ASTM Standard E2109-01 (Reapproved 2014) “Standard Test Methods for Determining Area Percentage Porosity in Thermal Sprayed Coatings). Flexing of the Yankee drum walls occurs during use as the cylinder walls bow out locally under centrifugal forces as well as internal pressures caused by pressurized steam used to heat the Yankee.

A Yankee dryer drum that has been coated in accordance with the herein described method can be installed, or reinstalled, in the tissue or papermaking line where it carries the papermaking web around a portion of its circumference while heating the web to substantial dryness, so it can be taken off at the doctor blade device for rolling on a take-up roll. It is in the increased longevity of the doctor blade, reduced wear rate of the yankee dryer shell and the consequent reduced downtime that the present Yankee dryer drums prove their value. While not wishing to be bound to a particular theory, it is believed that the coating provided by the present method maintains its composition substantially constant through the coating depth in contrast to prior art coating materials which change in composition through depth, sometimes through loss of an element such as chromium. Owing to the substantially constant composition throughout the depth of the coating applied by the present method, wear of the coating does not adversely affect the coating properties. Resistance to tribological wear, chemical wear and erosive wear remains effective over time. Continuing effective wear resistance means that the coating surface will not become rough as wear progresses or because of compositional changes. A lack of increase in surface roughness means that the doctor blade at the take-off location does not wear unduly or irregularly, which in turn prolongs the service life of the doctor blade. As the coating provided by the present method wears, it wears evenly. This may result in better productivity, less downtime, and less unsatisfactory product produced. In its papermaking production aspects, the present disclosure provides a coating interposed between the tissue or papermaking web and the Yankee dryer drum surface which coating enables some or all of the above-described advantages. A coated Yankee dryer drum affording these same advantages is further provided. Selection of the coating alloy raw material (the coating “feedstock”) and the thermal spraying process, gas types, pressures and flows in accordance with this invention substantially reduces or eliminates any off gassing of Hexavalent Chromium into the air during thermal spraying and subsequent grinding, and there are substantially no emissions of Hexavalent chromium to the floor of the site.

The coating feedstock used for forming the wear-resistant coating layer in accordance with the present disclosure consists of:

1.5 to 2.5 weight percent Al
0.0 to 0.2 weight percent Ti,
9.5 to 10.5 weight percent Si,
0.0 to 0.2 weight percent B,
12.5 to 14.2 weight percent Mo,
0.0 to 0.2 weight percent V,
0.0 to 0.2 weight percent C,
0.000 to 0.020 weight percent Cr,
4.5 to 6.0 weight percent Mn,
0.0 to 0.2 weight percent Mg,
0.0 to 0.2 weight percent Ni,
0.0 to 0.2 weight percent Nb,
the remainder being iron and impurities.

In the present disclosure, the term “impurities” should be considered to mean unavoidable impurities resulting from the raw material(s) used for, or resulting from, the manufacturing process for producing the coating feedstock, unless explicitly stated otherwise.

According to one embodiment, the coating feedstock used for forming the wear-resistant coating layer consists of:

1.90 to 2.10 weight percent Al
0.00 to 0.02 weight percent Ti,
9.90 to 10.20 weight percent Si,
0.00 to 0.02 weight percent B,
13.00 to 13.60 weight percent Mo,
0.00 to 0.02 weight percent V,
0.00 to 0.02 weight percent C,
0.000 to 0.010 weight percent Cr,
5.00 to 5.60 weight percent Mn,
0.00 to 0.02 weight percent Mg,
0.00 to 0.02 weight percent Ni,
0.00 to 0.02 weight percent Nb,
the remainder being iron and impurities.

The present disclosure further provides a method of forming a substantially homogeneous coating against tribological wear on a Yankee dryer drum, including thermal spraying the coating onto the web contacting surfaces of the dryer drum. Since during use of a Yankee drum there is continual wear, the capacity of a coating according to the present disclosure to maintain a high degree of uniformity of composition continuous through the coating thickness, rather than have the coating composition vary and possibly vary the method, quality and efficiency of tissue or papermaking with a Yankee dryer, including passing a tissue or paper formed web over a Yankee dryer drum in drying relation, and interposing between the paper-making web and the dryer drum a tribological and erosive wear limiting coating becomes paramount. Tribological wear will cause development of surface imperfections, manifested generally as roughness, loss of doctor blade efficiency, and deterioration in efficiency and productivity.

It is accordingly an object of the invention to provide a method of coating Yankee dryers with a hard but ductile coating composition which preferably provides a substantially uniform coating composition through its effective depth so that wear resistance is substantially constant in progressing through the coating as it wears during use and to provide Yankee dryer drums with a novel tribological and erosion wear resistant non-toxic coating.

The present disclosure further provides a coated Yankee dryer comprising a drum, the drum having a tribological and erosive wear limiting iron alloy coating wherein the iron alloy coating has the composition:

1.5 to 2.5 weight percent Al
0.0 to 0.2 weight percent Ti,
9.5 to 10.5 weight percent Si,
0.0 to 0.2 weight percent B,
12.5 to 14.2 weight percent Mo,
0.0 to 0.2 weight percent V,
0.0 to 0.2 weight percent C,
0.000 to 0.020 weight percent Cr,
4.5 to 6.0 weight percent Mn,
0.0 to 0.2 weight percent Mg,
0.0 to 0.2 weight percent Ni,
0.0 to 0.2 weight percent Nb,
the remainder being iron and impurities.

More preferably the sprayed-on coating of this invention consists of:

1.90 to 2.10 weight percent Al
0.00 to 0.02 weight percent Ti,
9.9 to 10.20 weight percent Si,
0.00 to 0.02 weight percent B,
13.00 to 13.60 weight percent Mo,
0.00 to 0.02 weight percent V,
0.00 to 0.02 weight percent C,
0.000 to 0.010 weight percent Cr,
5.00 to 5.60 weight percent Mn,
0.00 to 0.02 weight percent Mg,
0.00 to 0.02 weight percent Ni,
0.00 to 0.02 weight percent Nb,
the remainder being iron and impurities.

Optionally, a bond coating layer may be interposed between the outer surface of the cylindrical shell of the Yankee drying cylinder and the wear-resistant coating layer. Such a bond coating layer may further facilitate the bonding of the wear-resistant coating to the outer surface of the drum. Such a bond coating may stabilize the underlying cast iron or steel substrate and cover any small defects—especially with a cast iron shell that can have areas of harder and softer material/more or less porosity/inclusions/other defects that result from the casting process.

In all embodiments of the invention, the final coating (that is, any bond coating layer and the wear-resistant coating layer after machining) preferably has a thickness of 100 μm-3990 μm wherein the wear-resistant coating layer is equal to or greater than 100 μm and equal to or less than 1990 μm thick, and if a bonding coating is applied then the bond coating layer is equal to or greater than 1.00 and equal to or less than 2000 μm thick, the coating preferably has a porosity which is equal to or less than 5% and preferably is greater than or equal to 1% as determined by ASTM Standard E2109-01 (Reapproved 2014) “Standard Test Methods for Determining Area Percentage Porosity in Thermal Sprayed Coatings), the coating preferably has a diamond pyramid hardness (DPH) determined by ASTM E384-10, “Standard Test Method for Knoop and Vickers Hardness of Materials”, which is equal to or greater than 650 and equal to or less than 1004; the coating preferably is either low Chrome (that is, equal to or less than 0.020 weight %) or free of chromium, and is an iron alloy.

More preferably, in the final coating the wear-resistant coating layer is equal to or greater than 650 μm and equal to or less than 850 thick and the final coating is thermally sprayed onto the drum to form a coating in which the layer of wear resistant coating has a hardness from 650-1004 DPH. Preferably the wear resistant coating has homogenous coating properties throughout the thickness of the wear resistant coating. The porosity of the wear resistant coating helps liquid chemical coatings which are applied to the exposed surface of the wear resistant coating to stick to the wear resistant coating. Such porosity remains as the wear resistant coating wears, which is in contrast to prior art devices which relied on surface roughness to help the liquid chemical coating to stick to the wear resistant coating of the Yankee. Surface roughness helps the liquid chemical coating to stick to the wear resistant coating as it dries but this effect diminishes as the prior art coatings become smooth with wear, thereby becoming less effective at maintaining the dried liquid chemical coating on the surface of the wear resistant coating, while the porosity of the presently disclosed coating remains substantially the same as the surface wears, thereby remaining equally effective at maintaining the dried liquid chemical coating on the surface of the wear resistant coating throughout the service life of the coating.

A method according to the invention comprises providing a Yankee drying cylinder having a cylindrical shell or drum with a circular cross-section and an outer surface and performing a thermal spray operation to form a wear-resistant coating layer on the outer surface of the Yankee drying cylinder during which thermal spray operation coating feedstock according to the present invention is fed to one or more spray devices, heated to become plastic and/or semi-molten and/or molten and sprayed onto the outer surface of the shell of the Yankee drying cylinder to form the wear-resistant coating layer. The coating feedstock for the thermal spray operation preferably comprises no Chromium or only a small amount of Chromium which is equal to or greater than 0.000 and equal to or less than 0.050 weight percent, preferably equal to or less than 0.020 weight percent, and more preferably is equal to or less than 0.010 weight percent. The outer surface of the shell may be sprayed until the wear-resistant coating layer has obtained a thickness of 680 μm-2000 μm, preferably 800 μm to 1000 μm. Subsequently, on the now coated outer surface, a grinding operation may be performed, and the outer surface may then be polished. Preferably, any grinding and polishing operations are carried out such that, after the grinding operation and the polishing operation, the wear-resistant coating layer has a residual thickness from 100 μm-1990 μm, preferably 650 μm to 850 μm.

In some cases, it may be suitable to apply an optional bond coating layer to the outer surface of the circular cylindrical shell before the wear-resistant coating is applied. The bond coating layer is intended to stabilize the outer surface of the steel shell, to pacify imperfections from the casting process for a cast iron shell and to improve adherence of the wear-resistant coating layer to the circular cylindrical shell. In embodiments of the present disclosure, the application of the wear-resistant coating layer may be preceded by the steps of:

performing an initial first grinding operation on the outer surface of the shell;
grit blasting the outer surface after the initial grinding operation;
optionally coating the ground and grit blasted outer surface to form a bond coating layer on the ground and grit blasted surface. Said coating operation to form a bond coating layer may for example be performed by an initial spraying operation. During any said initial thermal spraying operation a bond coating feedstock is fed to one or more thermal spray devices, heated to become plastic and/or semi-molten and/or molten and sprayed onto the ground and grit blasted outer surface to form the bond coating layer. The bond coating feedstock for any such initial thermal spraying operation is preferably a Ni—Al mixture or alloy consisting essentially of Ni and Al and unavoidable impurities comprising Ni at an amount equal to or greater than 85.00 percent by weight and less than or equal to 98.00 percent by weight and Al at an amount equal to or less than 15.00 percent by weight and equal to or greater than 2.00 percent by weight. The wear-resistant coating layer according to the invention is subsequently applied on top of the bond coating layer. The thickness of the bond coating layer is preferably equal to or greater than 1.00 μm and equal to or less than 2000 μm and more preferably 10 μm to 30 μm. Preferably each pass of the thermal spraying device, commonly called a “gun”, adds 10-20 μm additional bond coat thickness.

In all embodiments of the present disclosure, the method may optionally comprise the step of applying a sealant, for example mono ammonium phosphate or di ammonium phosphate dissolved in water, to the wear-resistant coating layer over the surface of the wear-resistant coating layer. Ammonium dihydrogen phosphate (ADP), commonly called mono ammonium phosphate (MAP) is a chemical compound with formula NH6PO4. It is a white crystalline solid consisting of ammonium cations [NH4]+ and dihydrogen phosphate anions [H2PO4]− in equal proportion.

MAP has a moderately low pH that remains almost constant at different concentrations.

Diammonium phosphate (DAP) chemical formula (NH4)2HPO4, is one of a series of water-soluble ammonium phosphate salts that can be produced when ammonia reacts with phosphoric acid.

MAP and DAP create a uniform bonding surface on the Yankee dryer to help protect the finished surface and to assist it to accept the blended chemical coating added during the paper and tissue making processes. Much like priming a metal surface prior to painting, MAP was originally used in the metal plating industry to prep the metal surfaces to accept the plating metals. MAP and DAP do a similar job for Yankee coating—it assists the blended chemical coating applied during the paper making process to more readily adhere to the Yankee surface and to adhere in a uniform and even manner.

MAP and DAP also forms a hard-micro surface on cast iron Yankees that will over time create a harder surface. Cast iron has a Rockwell hardness of 23—but, for example, when continuously exposed to MAP the Rockwell hardness increases to 35. This harder micro-surface helps protect the Yankee from damage.

MAP and DAP not only spread the coating uniformly it also can assist in accelerating the cross linking of the organic polymer used in the chemical coating applied to the Yankee surface.

MAP and DAP will help prevent corrosion by interfering with electron transfer across the water phase and the Yankee surface. This is especially important in mills susceptible to Yankee cylinder edge crevasse build-up.

As cast-iron cylinders age they become more porous. MAP and DAP will tend to help fill these voids and allow for a more uniform surface. The benefit is fewer sheet breaks through holes & picking of the tissue sheet on the creping blade and a delay in further degradation of the Yankee cylinder surface.

Most phosphate coatings serve as a surface preparation for further coating. A function they perform effectively with excellent adhesion and electric isolation. The porosity allows the additional materials to seep into the phosphate coating after drying and become mechanically interlocked. The dielectric nature electrically isolates anodic and cathodic areas on the surface, minimizing under-film corrosion that sometimes occurs at the interface of the coating and substrate; it also minimizes the risk for graphitic corrosion in cast iron.

MAP and DAP can be very beneficial in protecting the Yankee surface and establishing a good Yankee organic coating. Other benefits of using MAP and DAP are that scratches and porosity can be somewhat filled and a level of corrosion resistance can be achieved.

Due to the combination of hydrophobic and hydrophilic properties between the wet pulp or web to the coated surface, the contact and release-ability are key factors to allow the “pickup” of the web and “release” of the tissue during tissue paper manufacturing. This feature of porosity, also called, “Surface Texturing” enhances the ability to speed up tissue paper operations for paper making and realizing a more economical product and also allows for the reduction of wear on both the Yankee and doctor blade surfaces allowing tissue operations to continue for long periods without interruption.

In embodiments of the present disclosure, the polishing operation may be performed until the surface of the wear-resistant layer has obtained a surface roughness Ra in the range of 0.1 μm-1.2 μm, preferably in the range of 0.2 μm-0.8 μm.

Preferably, the wear-resistant coating on the surface of the Yankee cylinder consists of:

1.5 to 2.5 weight percent Al,
0.0 to 0.2 weight percent Ti,
9.5 to 10.5 weight percent Si,
0.0 to 0.2 weight percent B,
12.5 to 14.2 weight percent Mo,
0.0 to 0.2 weight percent V,
0.0 to 0.2 weight percent C,
0.000 to 0.020 weight percent Cr,
4.5 to 6.0 weight percent Mn,
0.0 to 0.2 weight percent Mg,
0.0 to 0.2 weight percent Ni,
0.0 to 0.2 weight percent Nb,
the remainder being iron and impurities,
and preferably the coating has an ASTM E384-10 DPH hardness equal to or greater than 650 and equal to or less than 1004.

More preferably the wear-resistant coating according to the present disclosure consists of:

1.90 to 2.10 weight percent Al
0.00 to 0.02 weight percent Ti,
9.9 to 10.20 weight percent Si,
0.00 to 0.02 weight percent B,
0.00 to 0.02 weight percent V,
0.00 to 0.02 weight percent C,
0.000 to 0.010 weight percent Cr,
5.00 to 5.60 weight percent Mn,
0.00 to 0.02 weight percent Mg,
0.00 to 0.02 weight percent Ni,
0.00 to 0.02 weight percent Nb,
the remainder being iron and impurities,
and has preferably an ASTM E384-10 hardness equal to or greater than 650 and equal to or less than 1004.

In a first exemplified embodiment of the present disclosure the coating feedstock used to form the wear-resistant coating layer consists of

1.5 to 2.5 weight percent Al,
0.0 to 0.2 weight percent Ti,
9.5 to 10.5 weight percent Si,
0.0 to 0.2 weight percent B,
12.5 to 14.2 weight percent Mo,
0.0 to 0.2 weight percent V,
0.0 to 0.2 weight percent C,
0.000 to 0.020 weight percent Cr,
4.5 to 6.0 weight percent Mn,
0.0 to 0.2 weight percent Mg,
0.0 to 0.2 weight percent Ni,
0.0 to 0.2 weight percent Nb,
the remainder being iron and impurities.

Preferably, the coating feedstock comprises

1.90 to 2.10 weight percent Al
0.00 to 0.02 weight percent Ti,
9.9 to 10.20 weight percent Si,
0.00 to 0.02 weight percent B,
0.00 to 0.02 weight percent V,
0.00 to 0.02 weight percent C,
0.000 to 0.010 weight percent Cr,
5.00 to 5.60 weight percent Mn,
0.00 to 0.02 weight percent Mg,
0.00 to 0.02 weight percent Ni,
0.00 to 0.02 weight percent Nb,
the remainder being iron and impurities.

In embodiments of the invention, the at least one or more thermal spray devices that act against a part of the outer surface of the shell to apply coating for the wear-resistant coating layer to that part of the outer surface is operated at a distance from that part of the outer surface which is in the range of 50 mm-260 mm and preferably at a distance in the range of 60 mm-225 mm. More specifically, the outlet (where the feedstock exits the spray device) of the thermal spray device may be arranged at said distance from that part of the outer surface. In embodiments where a bond coating layer is applied by usage of a thermal spray device, such a spray device may be operated at a similar distance from the outer surface as in the case of the thermal spraying to form the wear-resistant coating.

In embodiments of the invention, when the at least one or more thermal spray device acts against a part of the outer surface of the shell to apply a wear-resistant coating layer to that part of the outer surface, the plastic and/or semiplastic and/or molten feedstock is sprayed onto the outer surface of the shell at an angle of 30°-90° with respect to that part of the outer surface, preferably at an angle of 45°-90° and even more preferred at an angle in the range of 75°-90°.

In embodiments in which an initial thermal spraying is carried out to form a bond coating layer, in order to prevent oxidation of the exposed cylinder outer surface, the initial thermal spraying operation may be initiated less than or equal to 90 minutes after the grit blasting has been completed, preferably less than or equal to 45 minutes and even more preferred less than or equal to 5 minutes after the grit blasting has been completed—Preferably the initial thermal spraying operation is carried out at such a rate that the entire outer surface has been covered in less than or equal to 3 hours after the grit blasting has been completed.

In order to reduce spraying time, both for applying the wear-resistant coating layer and for applying the bond coating layer (where applicable), preferably at least one, more preferably at least two or three thermal spray devices, and more preferably up to nine thermal spray devices, may be used simultaneously during at least one of the thermal spray operations. Thermal spray devices may be arranged in banks of thermal spray devices, for example one or two or three or more, thermal spray devices, and there may be a plurality of banks of thermal spray devices, for example three, banks of two or three or more thermal spray devices. Even more than 9 thermal spray devices arranged in banks may be used, for example for large cylinders, to reduce the process time.

Both for applying the wear-resistant coating layer and for applying the bond coating layer, a single thermal spray gun may be used, or one, two or three or more in groups or banks of thermal spray devices may be used simultaneously during at least one of the thermal spray operations, each group comprising one or more spray devices.

Although the wear resistant coating layer is substantially inert, in order to prevent rusting, oxidation or damage, preferably the grinding and/or polishing operation that follows the forming of the wear-resistant coating layer is initiated less than or equal to 15 minutes, preferably less than or equal to 10 minutes after the thermal spraying of the wear-resistant coating layer has been completed.

In all embodiments of the present disclosure, the coating feedstock that is fed to the at least one spray device to form the wear-resistant coating layer may come in the shape of two wires, each wire having a diameter in the range of 1.1 mm-3.8 mm.

In an embodiment of the invention, at least one thermal spray device is an arc spray gun. When more than one thermal spray device is used, all thermal spray devices may optionally be arc spray guns. Different thermal spray devices and different types of thermal spray devices may be used for applying the bond coating layer and for applying the wear resistant coating layer.

In an embodiment of the invention, at least one thermal spray device is a HVOF spray device. When more than one thermal spray device is used, all thermal spray devices may optionally be HVOF guns.

In an embodiment of the invention, at least one thermal spray device is a HVAF spray device. When more than one thermal spray device is used, all thermal spray devices may optionally be HVAF guns.

In an embodiment of the invention, at least one thermal spray device is a plasma spray gun. When more than one thermal spray device is used, all thermal spray devices may optionally be plasma spray guns.

In an embodiment of the invention, at least one thermal spray device is a water stabilized plasma spray gun. When more than one thermal spray device is used, all thermal spray devices may optionally be water stabilized plasma spray guns.

In an embodiment of the invention, at least one thermal spray device is a combustion powder spray device. When more than one thermal spray device is used, all thermal spray devices may optionally be combustion powder spray devices.

In an embodiment of the invention, at least one thermal spray device is a wire spray device. When more than one thermal spray device is used, all thermal spray devices may optionally be wire spray devices.

In embodiments of the invention, the thermal spraying operation for forming the wear-resistant coating layer may be carried out such that, during the thermal spraying operation, each wire is fed to the at least one spray device at a rate of 40 mm/second-90 mm/second, while the at least one spray device operates at a voltage in the range of 28-40 Volts, preferably 32-33 Volts and an amperage in the range of 100 Amps-350 Amps, preferably 125-250 A.

The invention further contemplates the method of forming a coating on a Yankee dryer drum surface for protection against tribological and erosive wear by thermal spraying a composition onto said surface, said composition establishing a drum coating; with a ASTM E384-10 DPH hardness equal to or greater than 650 and equal to or less than 1004

whereby erosive wear of said drum dryer surface caused by chemical action of chloride, fluoride, and sulfite ions during papermaking is resisted. This is achieved by thermal spraying an iron based alloy coating feedstock according to the present disclosure onto the web-contacting surface. Preferably, special thermal arc parameters are adapted to eliminate or reduce any Hexavalent chromium emissions. To that end, it is preferable that iron based alloy coating feedstocks according to the present disclosure are sprayed using a thermal arc process using the following parameters:

| | | |
|---|---|---|
| Primary | 60 psi | Gas Type: |
| Pressure | (0.414 MPa) | Air or Nitrogen |
| Secondary | 0-60 psi | Gas Type: |
| Pressure | (0-0.414 MPa) | Air or Nitrogen |
| Voltage | 32-33 V | 32-33 V |
| Amperage | 125-250 A | 125-250 A |
| Spray | 6-9″ (15.25 | 6-9″ (15.25 |
| Distance | to 22.86 mm) | to 22.86 mm) |

Alternatively, the iron based alloy coating feedstock according to the present disclosure can be applied in the form of a powder using a combustion spraying method such as HVOF spraying, HVAF spraying, or combustion powder spraying. In such cases, preferably the exhaust gas temperature into which the powder is injected is of the order of 3000° C. and the powder is accelerated to initial speeds preferably equal to or greater than 100 m/s and equal to or less than 500 m/s. Preferred median particle diameters are equal to or greater than 5 μm and less than or equal to 70 μm, more preferably equal to or greater than 10 μm and less than or equal to 65 μm. The temperature of the exhaust gas, initial speed of the particles and the size of the particles are controlled by the process parameters which can be adjusted to achieve the desired porosity of the wear-resistant coating. The end effect of the process parameters are deliberate in order to achieve the desired structure of the coated and finish ground coating. Typically, increasing particle size alone leads to increased porosity.

Increasing gas velocity alone leads to increasing particle velocity which will decrease porosity.

Increasing temperature of the arc plume alone leads to less viscous droplets and decreases porosity.

### BRIEF DESCRIPTION OF THE DRAWINGS

FIG. 1 is a schematic representation of a Yankee drying cylinder during operation to produce paper.

FIG. 2 is a schematic representation in perspective of a Yankee drying cylinder.

FIG. 3 is a schematic representation of a step in the process of applying a coating layer to the surface of a Yankee drying cylinder.

FIG. 4 is a schematic representation of a further step in the process of applying a coating layer to the surface of a Yankee drying cylinder.

FIG. 5 is a schematic representation of how coating material is thermally sprayed onto the surface of the shell of the Yankee drying cylinder.

FIG. 6 is a schematic representation of how several spray devices may be used simultaneously to apply a coating layer to the outer surface of the Yankee drying cylinder.

FIG. 7 is a schematic representation of how a spray device may be oriented relative to the shell of the Yankee drying cylinder during application of a coating layer.

FIG. 8 is a schematic cross-sectional representation of a Yankee drying cylinder that has been coated in accordance with one embodiment of the present invention.

FIG. 9 is a schematic representation of a possible initial spraying step that precedes the step in which thermal spraying is used to form a wear-resistant coating layer.

FIG. 10 is a schematic cross-sectional representation of a Yankee drying cylinder that has been coated with a coating in accordance with the invention.

FIG. 11 is a schematic representation of a polishing step.

FIG. 12 is a schematic representation of a possible step at the end of the process of providing a wear-resistant coating layer.

### DETAILED DESCRIPTION OF THE INVENTION

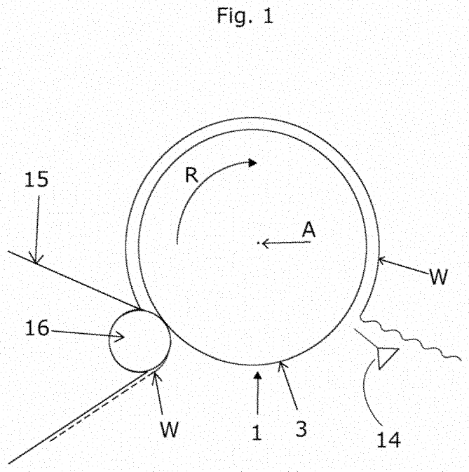

With reference to FIG. 1, a Yankee drying cylinder 1 is shown in operation during manufacture of a paper web such as a tissue paper web. In FIG. 1, a wet fibrous web W which comes from the forming section (not shown in FIG. 1) of a paper making machine is carried by a fabric such as a water-receiving felt 15 to a transfer nip formed between a transfer roll (or press roll) 16 and a Yankee drying cylinder 1. The transfer roll (or press roll) 16 may be lightly loaded against the Yankee drying cylinder 1, just sufficiently to form a transfer nip. Alternatively, the roll 16 may be loaded with a considerable force against the Yankee drying cylinder 1 and form a dewatering nip with the Yankee drying cylinder 1 such that water is pressed out of the fibrous web W. Water can also be removed by use of an internal vacuum box combined with a transfer roll (or press roll) with a perforated shell. In the nip, the fibrous web W is transferred from the fabric 15 to the outer surface 3 of the Yankee drying cylinder that is rotating in the direction of arrow R about its axis of rotation A which is also the longitudinal axis of symmetry of the Yankee drying cylinder 1. The Yankee drying cylinder 1 is heated to a high temperature, normally by means of hot steam that is supplied to the interior of the Yankee drying cylinder. The fibrous web W is ready-dried on the outer surface 3 of the Yankee drying cylinder 1 and creped off from the Yankee drying cylinder by a doctor 14. While not shown in the figures, it should be understood that the Yankee drying cylinder 1 normally has internal grooves from which condense water is evacuated during operation. The Yankee drying cylinder may a cast iron Yankee or a Yankee drying cylinder made of welded steel.

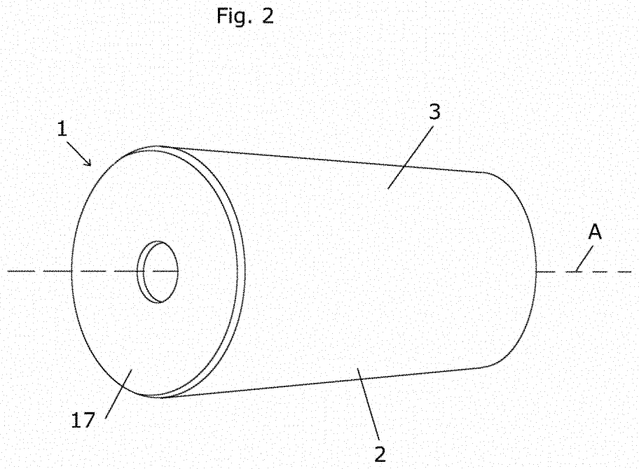

FIG. 2 shows an example of a Yankee drying cylinder in perspective. With reference to FIG. 2, the Yankee drying cylinder 1 comprises a circular cylindrical shell 2 which is designed to be capable of receiving hot steam. The cylindrical shell with a circular cross-section has an outer surface 3. The internal grooves of the Yankee drying cylinder 1 (if present) are located on an internal surface of the shell 2. In FIG. 2, the Yankee drying cylinder also has end walls 17 of which only one can be seen in FIG. 2. The end walls 17 may be connected to the shell 2 by means of, for example, welding, screws or bolts.

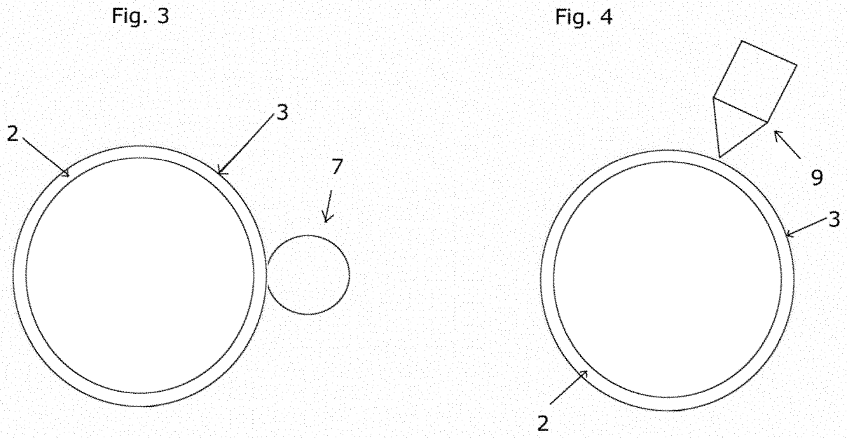

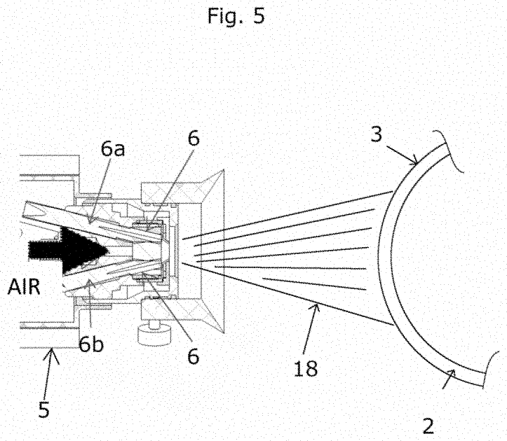

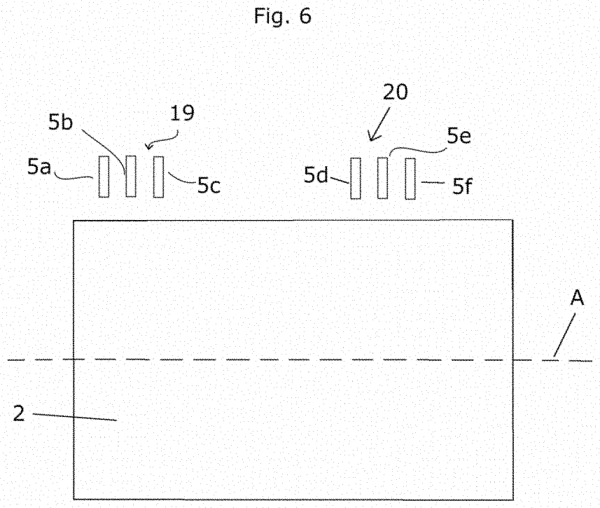

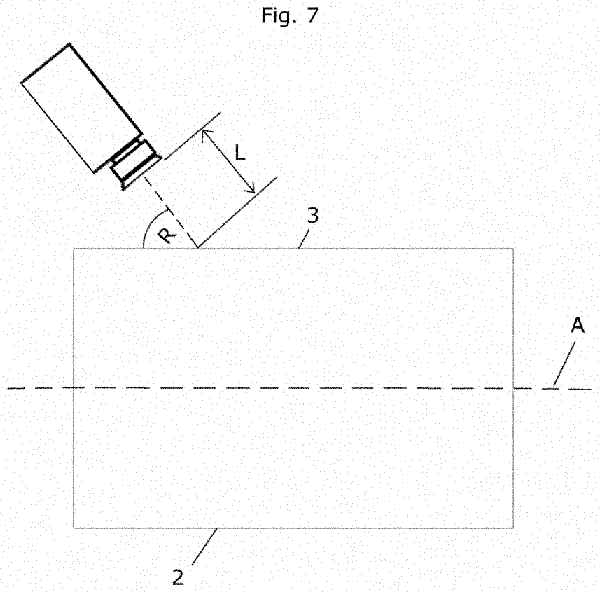

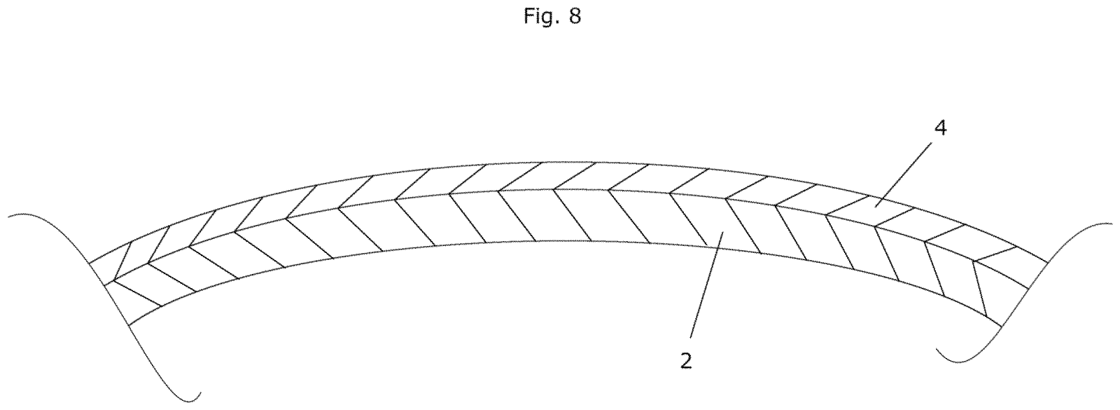

A first embodiment of the present invention will now be explained with reference to FIG. 3; FIG. 5; FIG. 6; FIG. 7; FIG. 8; and FIG. 11.

With reference to FIG. 5 and FIG. 8, a spray device 5, a thermal spray device 5 which may be, for example, an arc spray gun or HVOF or HVAF or plasma spray gun or water stabilized plasma spray gun, combustion powder spray device or wire spray device or combinations thereof or the like thereof, are used to apply a wear-resistant coating layer 4 (shown in FIG. 8) to the outer surface 3 of a circular cylindrical shell 2 which is part of a Yankee drying cylinder 1. A coating feedstock 6 is fed to the spray device 5, heated to become plastic and/or semi-molten and/or molten and sprayed onto the outer surface 3 of the shell 2. As indicated in FIG. 5, the coating feedstock 6 may comprise two separate wires 6a, 6b. The wires 6a, 6b are electrically charged—one being positive and the other being negative. The wires 6a, 6b are molten when they come into close proximity or are in contact with each other and, as schematically indicated in FIG. 5, air (or gas) is used to blow the molten feedstock onto the outer surface 3 in a spray 18 that lands as small droplets on the outer surface These droplets form a wear-resistant coating layer 4 on the circular cylindrical shell 2.

It has previously been common to use a feedstock that comprises relatively high amounts of chromium in order to form a coating layer that is resistant to wear, oxidation, corrosion, and chemical attack. While the use of chromium does indeed result in a high resistance to wear, chromium represents a health hazard to the workers, especially during the process for applying the wear resistant coating on the Yankee. For this reason, it is desirable to minimize the use of chromium and preferably eliminate chromium altogether from the process. Therefore, the inventors of the present invention have seen that there is a need to provide a coating method that eliminates or at least minimizes the use of chromium but still succeeds in achieving a coating layer that has a high degree of resistance to wear.

The inventors have found that this can be achieved if the coating feedstock 6 that is fed to at least one spray device 5 and that is used for the thermal spray operation is formed by a material that consists of:

1.5 to 2.5 weight percent Al
0.0 to 0.2 weight percent Ti,
9.5 to 10.5 weight percent Si,
0.0 to 0.2 weight percent B,
12.5 to 14.2 weight percent Mo,
0.0 to 0.2 weight percent V,
0.0 to 0.2 weight percent C,
0.000 to 0.020 weight percent Cr,
4.5 to 6.0 weight percent Mn,
0.0 to 0.2 weight percent Mg,
0.0 to 0.2 weight percent Ni,
0.0 to 0.2 weight percent Nb,
the remainder being iron and impurities.

More preferably the feedstock of this invention consists of:

1.90 to 2.10 weight percent Al
0.00 to 0.02 weight percent Ti,
9.90 to 10.20 weight percent Si,
0.00 to 0.02 weight percent B,
0.00 to 0.02 weight percent V,
0.00 to 0.02 weight percent C,
0.000 to 0.010 weight percent Cr,
5.00 to 5.60 weight percent Mn,
0.00 to 0.02 weight percent Mg,
0.00 to 0.02 weight percent Ni,
0.00 to 0.02 weight percent Nb,
the remainder being iron and impurities.

Most preferably the sum of Al+Mn+Si is equal to or greater than 17.50 and equal to or less than 17.70 weight percent.

Preferably, the outer surface of the shell 2 should also be sprayed until the wear-resistant coating layer 4 has obtained a thickness equal to or greater than 680 μm and equal to or less than 2000 μm, more preferably equal to or greater than 800 μm and equal to or less than 1000 μm. Thereafter, a grinding operation is performed on the wear-resistant coating layer. A grinding operation is symbolically indicated in FIG. 3 in which a grinding tool 7 acts on the now coated outer surface 3. The grinding operation is followed by polishing of the coated outer surface such that, after the grinding operation and the polishing operation, the wear-resistant coating layer 4 has a thickness equal to or greater than 100 μm and equal to or less than 1990 μm, preferably equal to or greater than 650 μm and equal to or less than 850 μm. The polishing operation is indicated schematically/symbolically in FIG. 11 in which a polishing device 8 acts on the coated surface 3. The polishing operation should preferably (but not necessarily) be carried out until the surface of the wear-resistant layer 4 has obtained a surface roughness Ra equal to or greater than 0.1 μm and equal to or less than 1.2 μm, more preferably equal to or greater than 0.2 μm and equal to or less than 0.8 μm.

The wear-resistant coating layer 4 indicated in FIG. 8 is not to scale.

When the coating feedstock 6 comes in the shape of wires 6a, 6b, each wire may advantageously have a diameter preferably equal to or greater than 1.1 mm and equal to or less than 3.8 mm.

When wires 6a, 6b are used as feedstock to form the wear-resistant coating layer 4, the thermal spraying operation is preferably (but not necessarily) carried out such that each wire is fed to the at least one spray device 5 at a rate preferably equal to or greater than 40 mm/second and equal to or less than 90 mm/second. The at least one spray device 5 preferably (but not necessarily) operates at a voltage preferably equal to or greater than 28 and equal to or less than 40 Volts and an amperage preferably equal to or greater than 100 Amps and equal to or less than 350 Amps.

With reference to FIG. 6, several thermal spray devices 5 may be used and several spray devices may be arranged in groups. In the arrangement of FIG. 6, six spray devices 5a-5f are used simultaneously and three spray devices 5a, 5b and 5c are operating together in a group 19 while three spray devices 5d, 5e and 5f are arranged in a group 20. It should be understood that each group may comprise of one, two, three or more than three spray devices and more than one group may be used simultaneously with other groups of spray devices. For example, two, three, four or five groups of spray devices could be used. Conceivably, two spray devices 5 could also be arranged in a pair and operate together. Conceivably, several pairs of spray devices could also be used simultaneously. For example, one, two, three or four pairs could be used or more than four pairs. While the method may be carried out with only one spray device 5, the simultaneous use of several spray devices makes it possible to form the coating layer in a shorter time. The use of spray devices operating close to each other in pairs or groups can result in a more even coating result.

With reference to FIG. 7, it may be advantageous to arrange the at least one spray device 5 (or several spray devices 5) such that, when the at least one spray device 5 acts against a part of the outer surface of the shell to apply coating to that part of the outer surface, the molten feedstock is sprayed onto the outer surface of the shell 2 at an angle R with respect to that part of the outer surface. The angle R is preferably in the range of 30°-90°, preferably in the range of 45°-90° and even more preferred in the range of 75°-90°.

With further reference to FIG. 7, the at least one spray device 5 is operated at a distance L from that part of the outer surface 3 against which it acts at a given moment which is in the range of 50 mm-260 mm and preferably at a distance in the range of 60 mm-225 mm.

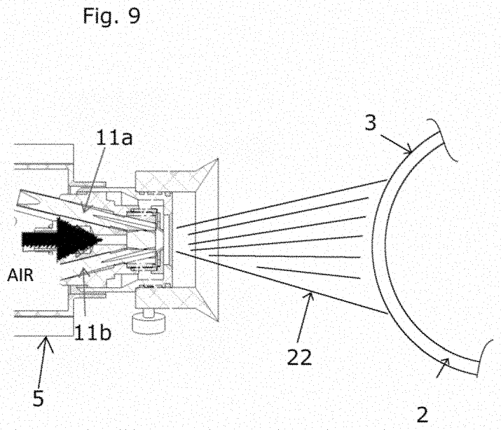

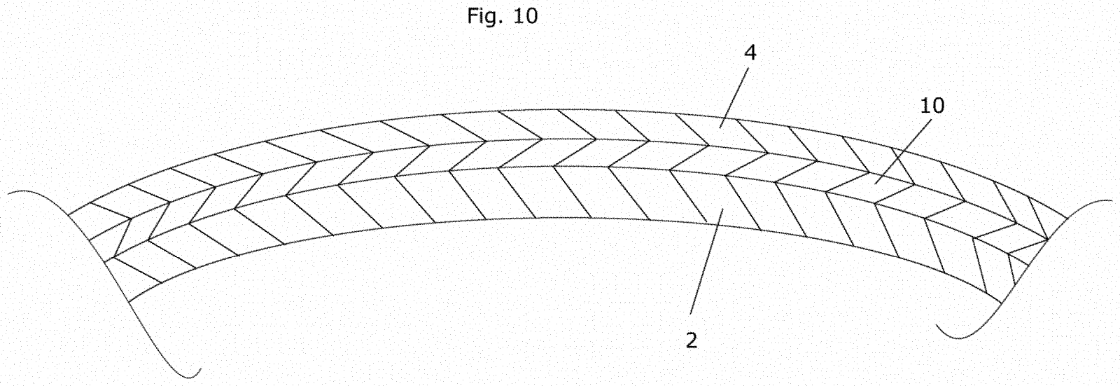

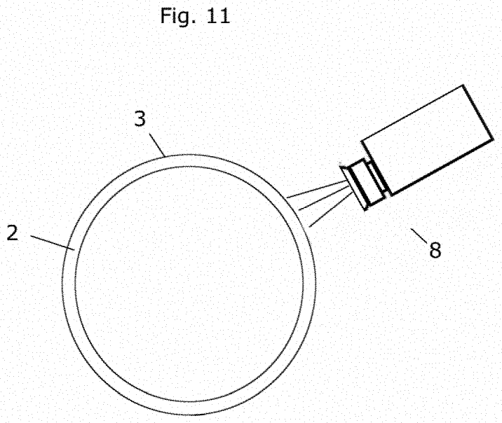

An advantageous embodiment of the inventive method will now be explained with reference to FIG. 3; FIG. 4; FIG. 9: and FIG. 10. In some cases, it may be suitable to apply an optional bond coating layer to the outer surface 3 of the circular cylindrical shell 2 before the wear-resistant coating 4 is applied. The bond layer is intended to improve adherence of the wear-resistant coating layer to the circular cylindrical shell 2.

When a bond layer is applied before the wear-resistant coating layer 4 is formed, the procedure may suitably be as follows. An initial grinding operation (as symbolically indicated in FIG. 3) is performed on the outer surface 3 of the shell 2. At this stage, the outer surface 3 may be simply a surface formed by cast iron or by steel. After the initial grinding operation has been performed, the outer surface 3 is grit blasted by a grit blasting device 9 as shown in FIG. 4. The ground and grit blasted surface 3 is then coated in an initial thermal spraying operation in substantially the same way as previously described with reference to the forming of the wear-resistant coating layer except that a different coating feedstock is used. The initial thermal spraying operation will form a bond coating layer 10 for the subsequently applied wear resistant coating layer. After the bond coating layer 10 has been formed, this bond coating layer will temporarily form the (new) outer surface 3 of the shell 2. With reference to FIG. 9, coating feedstock in the shape of two wires 11a, 11b is fed to a thermal spray device 5. The coating feedstock 11a, 11b is heated to become plastic and/or semi-molten and/or molten and is sent in a spray 22 onto the surface of the shell 2. As with the coating for the wear-resistant layer, air or gas as indicated by the arrow in FIG. 9 may be used to force the molten feedstock towards the surface 3 of the shell 2.

The coating feedstock 11a, 11b that is used in the initial thermal spraying operation surface to form the bond coating layer 10, consists of from 85 to 98 percent by weight Ni and from 2 to 15 percent by weight Al and unavoidable impurities.

When the bond coating layer 10 has been formed, the wear-resistant layer 4 will subsequently be applied/formed on top of the bond coating layer 10.

With reference to FIG. 10, it can be seen that the circular cylindrical shell now has two coating layers, a bond layer 10 and a top layer 4 which is the wear-resistant layer. The inventors have found that the bond layer 10, when formed with the feedstock described above, significantly improves adherence of the wear-resistant layer.

To prevent undesired oxidation of the grit-blasted surfaces, the initial thermal spraying operation to form the bond coating layer is suitably initiated less than or equal to 90 minutes after the grit blasting has been completed, preferably less than or equal to 45 minutes and even more preferred less than or equal to 5 minutes after the grit blasting has been completed. However, other time intervals may also be considered.

The initial thermal spraying operation is preferably carried out at such a rate that the entire outer surface has been covered less than or equal to 3 hours after the grit blasting has been completed to prevent oxidation of the exposed outer surface.

The grinding operation that follows the forming of the wear-resistant coating layer 4 is preferably initiated less than or equal to 15 minutes after the thermal spraying operation has been completed, in particular less than or equal to 10 minutes.

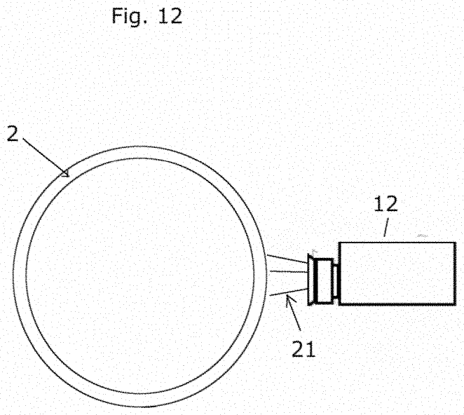

Both when the inventive method comprises the forming of a bond coating layer and when the wear-resistant coating layer is applied directly to the shell 2 without a bond coating layer, the method can suitably comprise an optional step of applying a sealant such as mono ammonium phosphate or di ammonium phosphate dissolved in water to the wear-resistant coating layer 4 evenly over the surface of the wear-resistant coating layer 4. With reference to FIG. 12, a device 12 for the application of mono ammonium phosphate or di ammonium phosphate sends a spray or jet of mono ammonium phosphate or di ammonium phosphate dissolved in water onto the shell 2 (and thereby also onto the wear-resistant coating layer 4 which now forms the outer surface 3 of the circular cylindrical shell 2).

MAP and DAP create a uniform bonding surface on the Yankee dryer to help protect the finished surface and to assist it to accept the blended chemical coating added during the paper and tissue making processes. Much like priming a metal surface prior to painting, MAP was originally used in the metal plating industry to prep the metal surfaces to accept the plating metals. MAP and DAP do a similar job for Yankee coating—it assists the blended chemical coating applied during the paper making process to more readily adhere to the Yankee surface and to adhere in a uniform and even manner.

Thanks to the method described herein, a wear-resistant coating can be formed with minimal or no use of chromium. Preferably the amount of chromium is equal or less than 0.020% by weight, more preferably up to or less than 0.010%, even more preferably equal to or less than 0.005% and most preferably zero. By using the present method, a wear-resistant coating layer can be formed which has a hardness in the range of 650-1004 DPH. The wear-resistant layer formed by the present method will be porous to some extent and the porosity is preferably equal to or less than 5% and preferably is greater than or equal to 1% % as determined by ASTM Standard E2109-01 (Reapproved 2014) “Standard Test Methods for Determining Area Percentage Porosity in Thermal Sprayed Coatings”.

1. A method of applying a wear-resistant coating on a Yankee drying cylinder (1), the method comprising:
a step of providing a Yankee drying cylinder (1) having a cylindrical shell (2) with a circular cross-section and an outer surface (3):
a step of performing a thermal spray operation to form a wear-resistant coating layer (4) on the outer surface of the Yankee drying cylinder (1) during which thermal spray operation coating feedstock (6) is fed to at least one first spray device (5), heated to become plastic and/or semi-molten and/or molten and sprayed onto the outer surface (3) of the Yankee drying cylinder (1) to form the wear-resistant coating layer (4), the coating feedstock (6) for the thermal spray operation consisting of:
1.5 to 2.5 weight percent Al
0.0 to 0.2 weight percent Ti,
9.5 to 10.5 weight percent Si,
0.0 to 0.2 weight percent B,
12.5 to 14.2 weight percent Mo,
0.0 to 0.2 weight percent V,
0.0 to 0.2 weight percent C,
0.000 to 0.020 weight percent Cr,
4.5 to 6.0 weight percent Mn,
0.0 to 0.2 weight percent Mg,
0.0 to 0.2 weight percent Ni,
0.0 to 0.2 weight percent Nb,
the remainder being iron and impurities.

2. The method of claim 1 wherein the step of thermal spraying the outer surface of the Yankee drying cylinder (1) is performed until the wear-resistant coating layer has obtained a thickness of 680 μm-2000 μm, preferably 800 μm to 1000 μm.

3. The method of claim 1 wherein the coating feedstock (6) for the thermal spray operation consists of:
1.90 to 2.10 weight percent Al
0.00 to 0.02 weight percent Ti,
9.90 to 10.20 weight percent Si,
0.00 to 0.02 weight percent B,
13.00 to 13.60 weight percent Mo,
0.00 to 0.02 weight percent V,
0.00 to 0.02 weight percent C,
0.000 to 0.010 weight percent Cr,
5.00 to 5.60 weight percent Mn,
0.00 to 0.02 weight percent Mg,
0.00 to 0.02 weight percent Ni,
0.00 to 0.02 weight percent Nb,
the remainder being iron and impurities.

4. The method according to claim 1 comprising the subsequent step of performing a grinding and/or polishing operation of the coated outer surface such that, after the grinding and/or polishing operation, the wear-resistant coating layer (4) has a thickness from 100 μm-1990 μm, preferably 650 μm to 850 μm.

5. The method according to claim 1, wherein the step of performing thermal spray operation to form the wear-resistant coating layer (4) is preceded by the steps of: performing an initial first grinding operation on the outer surface (3) of the shell (2); grit blasting the outer surface (3) after the initial first grinding operation; coating the ground and grit blasted outer surface (3) with a bond coating layer (10) having a composition different than the composition of the coating feedstock (6), and wherein the wear-resistant coating layer (4) is subsequently applied on top of the bond coating layer (10). bond

6. The method according to claim 5, wherein the coating of the ground and grit blasted outer surface (3) with a bond coating layer (10) is performed by an initial thermal spraying operation during which a bond coating feedstock is fed to at least one spray device (13), heated to become plastic and/or semi-molten and/or molten and sprayed onto the ground and grit blasted outer surface to form the bond coating layer (10), wherein the bond coating feedstock constituting a Ni—Al mixture or alloy consisting of from 85 to 98 percent by weight Ni and from 15 to 2 percent by weight Al and unavoidable impurities.

7. The method according to claim 6 wherein the thickness of the bond coating layer is greater than or equal to 1.00 μm and less than or equal to 2000 μm.

8. The method according to claim 6 wherein the thickness of the bond coating layer is greater than or equal to 10 μm and less than or equal to 30 μm.

9. The method according to claim 1, wherein the method comprises applying an aqueous solution comprising dissolved mono ammonium phosphate or di ammonium phosphate over the surface of the wear-resistant coating layer (4).

10. The method according to claim 4, wherein the grinding and/or polishing operation is performed until the surface of the wear-resistant layer (4) has obtained a surface roughness Ra in the range of 0.1 μm-1.2 μm, preferably in the range of 0.2 μm-0.8 μm.

11. The method according to claim 1, wherein, when the at least one spray device (5) acts against a part of the outer surface (3) of the shell (2) to apply the wear resistant coating to that part of the outer surface, the at least one spray device (5) is operated at a distance from that part of the outer surface (3) which is in the range of 50 mm-260 mm and preferably at a distance in the range of 60 mm-225 mm.

12. The method according to claim 1, wherein, when the at least one spray device (5) acts against a part of the outer surface of the shell to apply the wear-resistant coating to that part of the outer surface, the plastic and/or semiplastic and/or molten feedstock is sprayed onto the outer surface of the shell (2) at an angle of 30°-90° with respect to that part of the outer surface, preferably at an angle of 45°-90° and even more preferred at an angle in the range of 75°-90°.

13. The method according to claim 5, wherein the coating of the ground and grit blasted outer surface is initiated within at most 90 minutes after the grit blasting has been completed, preferably within at most 45 minutes and even more preferred within at most 5 minutes after the grit blasting has been completed.

14. The method according to claim 6, wherein the initial thermal spraying operation is carried out at such a rate that the entire outer surface has been covered within at most 3 hours after the grit blasting has been completed.

15. The method according to claim 1, wherein at least one, two, three or more spray devices (5) are used simultaneously during at least one of the thermal spray operations.

16. The method according to claim 1, wherein at least one or more group of spray devices (5) are used simultaneously during at least one of the thermal spray operations, each group comprising three or more spray devices (5).

17. The method according to claim 4, wherein the grinding and/or polishing operation that follows the forming of the wear-resistant coating layer (4) is initiated within at most 15 minutes after the thermal spraying operation to form the wear-resistant layer has been completed, preferably within at most 10 minutes.

18. The method according to claim 1, wherein the coating feedstock (6) for the at least one spray device comes in the shape of two wires, each wire having a diameter equal to or greater than 1.1 mm and equal to or less than 3.8 mm.

19. A method according to claim 1, wherein the at least one spray device (5) is an arc spray gun or HVOF or HVAF or plasma spray gun or water stabilized plasma spray gun, combustion powder spray device or wire spray device or the like.

20. A method according to claim 18, wherein, during the thermal spraying operation, each wire is fed to the at least one spray device (5) at a rate of 40 mm/second-90 mm/second, while the at least one spray device (5) operates at a voltage in the range of 28-40 Volts and an amperage in the range of 100 Amps-350 Amps.

21. A Yankee cylinder with a coating formed by the method of claim 1.

22. A Yankee cylinder according to claim 20 wherein the coating has a diamond pyramid hardness (DPH) determined by ASTM E384-10, “Standard Test Method for Knoop and Vickers Hardness of Materials”, which is equal to or greater than 650 and equal to or less than 1004.

23. A Yankee cylinder according to claim 21 wherein the coating has a porosity equal to or less than 5% and preferably greater than or equal to 1% as determined by ASTM Standard E2109-01 (Reapproved 2014) “Standard Test Methods for Determining Area Percentage Porosity in Thermal Sprayed Coatings”.

24. A coating feedstock for the thermal spray coating of a Yankee cylinder wherein the feedstock (6) consists of:
1.5 to 2.5 weight percent Al
0.0 to 0.2 weight percent Ti,
9.5 to 10.5 weight percent Si,
0.0 to 0.2 weight percent B,
12.5 to 14.2 weight percent Mo,
0.0 to 0.2 weight percent V,
0.0 to 0.2 weight percent C,
0.000 to 0.020 weight percent Cr,
4.5 to 6.0 weight percent Mn,
0.0 to 0.2 weight percent Mg,
0.0 to 0.2 weight percent Ni,
0.0 to 0.2 weight percent Nb,
the remainder being iron and impurities.

25. A coating feedstock for the thermal spray coating of a Yankee cylinder wherein the feedstock (6) consists of:
1.90 to 2.10 weight percent Al
0.00 to 0.02 weight percent Ti,
9.9 to 10.20 weight percent Si,
0.00 to 0.02 weight percent B,
13.00 to 13.60 weight percent Mo,
0.00 to 0.02 weight percent V,
0.00 to 0.02 weight percent C,
0.000 to 0.010 weight percent Cr,
5.00 to 5.60 weight percent Mn,
0.00 to 0.02 weight percent Mg,
0.00 to 0.02 weight percent Ni,
0.00 to 0.02 weight percent Nb,
the remainder being iron and impurities.
